(19) United States
(12) Patent Application Publication
(10) Pub. No.: US 2026/0093272 A1
(43) Pub. Date: Apr. 2, 2026

(54) SYSTEMS AND METHODS FOR COLLISION AVOIDANCE FOR AUTONOMOUS MOBILE ROBOTS USING SHORT-RANGE POSITION SHARING

(71) Applicant: CLEARPATH ROBOTICS INC., Kitchener (CA)

(72) Inventors: Ivor WANDERS, Kitchener (CA); Nathan WIEBE NEUFELDT, Kitchener (CA); Guillaume AUTRAN, Waterloo (CA)

(21) Appl. No.: 18/901,842

(22) Filed: Sep. 30, 2024

(51) Int. Cl. G05D 1/693; G05D 1/244; G05D 105/20; G05D 107/70; G05D 111/30; H04B 17/318; H04W 4/46; H04W 4/80

(52) U.S. Cl. CPC G05D 1/693; G05D 1/244; H04B 17/318; H04W 4/46; H04W 4/80; G05D 2105/20; G05D 2107/70; G05D 2111/30

(57) ABSTRACT

Various systems and methods for collision avoidance for autonomous mobile robots operating within a facility using short-range position sharing are disclosed herein. The systems and methods involve a first autonomous mobile robot broadcasting a low power presence signal via a short-range communication protocol, detecting a response signal from a second autonomous mobile robot and transmitting to the second autonomous mobile robot, a state signal including at least a current position and a current velocity of the first autonomous mobile robot. The second autonomous mobile robot determines its future positions along its trajectory and modifies its trajectory in response to determining a risk of collision, based on its future positions and predicted future positions of the first autonomous mobile robot. The predicted future positions are determined based at least on the current position and the current velocity of the first autonomous mobile robot.

### FIELD

The described embodiments relate to systems and methods collision avoidance for autonomous mobile robots using short-range position sharing.

### BACKGROUND

Autonomous mobile robots are becoming commonplace in industrial environments and are used for a variety of purposes, including for transporting loads within a facility. These robots can travel autonomously within industrial environments, using a combination of navigation commands received from a fleet manager or an operator, and external sensors located on the body of the robots that can obtain sensor data about the environment of the autonomous mobile robots.

These sensors are often key in helping autonomous mobile robots avoid collisions. When a sensor detects the presence of an obstacle that can pose a risk of collision, the autonomous mobile robot can come to a stop, or navigate around the obstacle.

External sensors used to detect objects are typically, however, located near the travel surface of the autonomous mobile robots (e.g., floor surface) and consequently their field of view can have a limited height, causing these sensors to fail to detect obstacles that are located at a distance from the travel surface. In facilities where autonomous mobile robots are used to transport loads however, this limited field of view can cause autonomous mobile robots to fail to detect overhanging loads (i.e., loads that have a larger footprint than the footprint of the autonomous mobile robot) which can cause autonomous mobile robots to collide.

### SUMMARY

The various embodiments described herein generally relate to systems and methods for collision avoidance for autonomous mobile robots using short-range position sharing.

In accordance with an example embodiment, there is provided a system for collision avoidance for autonomous mobile robots operating within a facility using short-range position sharing. The system includes a first autonomous mobile robot comprising a first communication component configured to: broadcast a low power presence signal via a short-range communication protocol; in response to detecting a response signal from a second autonomous mobile robot, transmit, to the second autonomous mobile robot, a state signal comprising at least a current position and a current velocity of the first autonomous mobile robot; and a second autonomous mobile robot. The second autonomous mobile robot includes a processor operable to determine at least one future position of the second autonomous mobile robot along a trajectory of the second autonomous mobile robot; and modify the trajectory of the second autonomous mobile robot in response to determining a risk of collision, based at least on the at least one future position of the second autonomous mobile robot and at least one predicted future position of the first autonomous mobile robot along a trajectory of the first autonomous mobile robot, the at least one predicted future position of the first autonomous mobile robot determined based at least on the current position and the current velocity of the first autonomous mobile robot.

In some embodiments, the first autonomous mobile robot is a material transport mobile robot having an overhanging load and the state signal comprises dimensions of the overhanging load.

In some embodiments, a rate of transmission of the low power presence signal is based in part on the current velocity of the first autonomous mobile robot.

In some embodiments, the state signal is transmitted via a second short-range communication protocol that is different from the short-range communication protocol of the low power presence signal.

In some embodiments, the state signal is transmitted via the short-range communication protocol.

In some embodiments, the second autonomous mobile robot comprises a second communication component configured to transmit a content of the state signal of the first autonomous mobile robot to a third autonomous mobile robot.

In some embodiments, the state signal further comprises at least one expected future position and at least one expected future velocity of the first autonomous mobile robot, and the processor of the second autonomous mobile robot is operable to: determine the at least one predicted future position of the first autonomous mobile robot based at least on the at least one expected future position and the at least one expected future velocity of the first autonomous mobile robot.

In some embodiments, the state signal further comprises mission information of the first autonomous mobile robot, the mission information comprising one or more of a mission type of the first autonomous mobile robot, a trajectory of the first autonomous mobile robot, a destination of the first autonomous mobile robot and a priority of the mission and the processor of the second autonomous mobile robot is operable to modify the trajectory of the second autonomous mobile robot based on the mission information.

In some embodiments, the state signal comprises a robot identifier of the first autonomous mobile robot, and wherein the second autonomous mobile robot is configured to retrieve, from a data storage, dimensions of a load of the first autonomous mobile robot based on the robot identifier and the processor of the second autonomous mobile robot is operable to determine the risk of collision based on the dimensions of the load of the first autonomous mobile robot.

In some embodiments, the state signal comprises a distance of the first autonomous mobile robot to a landmark within the facility and the processor of the second autonomous mobile robot is operable to update a localization information of the second autonomous mobile robot based on the distance of the first autonomous mobile robot to the landmark and a signal strength of the state signal.

In accordance with another example embodiment, there is provided a method for collision avoidance for autonomous mobile robots operating within a facility using short-range position sharing. The method involves operating a processor of a first autonomous mobile robot to: detect a low power presence signal broadcasted by a second autonomous mobile robot via a short-range communication protocol; transmit a response signal to the low power presence signal to the second autonomous mobile robot; receive, from the second autonomous mobile robot, a state signal comprising at least a current position and a current velocity of the second autonomous mobile robot; determine at least one future position of the first autonomous mobile robot along a trajectory of the first autonomous mobile robot; and modify the trajectory of the first autonomous mobile robot in response to determining a risk of collision, based at least on the at least one future position of the first autonomous mobile and at least one predicted future position of the second autonomous mobile robot along a trajectory of the second autonomous mobile robot the at least one predicted future position of the second autonomous mobile robot determined based at least on the current position and the current velocity of the second autonomous mobile robot.

In some embodiments, the second autonomous mobile robot is a material transport mobile robot having an overhanging load and the state signal comprises dimensions of the overhanging load.

In some embodiments, a rate of transmission of the low power presence signal is based in part on the current velocity of the second autonomous mobile robot.

In some embodiments, the state signal is transmitted via a second short-range communication protocol that is different from the short-range communication protocol of the low power presence signal.

In some embodiments, the state signal is transmitted via the short-range communication protocol.

In some embodiments, the method further comprises operating the processor of the first autonomous mobile robot to transmit a content of the state signal of the second autonomous mobile robot to a third autonomous mobile robot.

In some embodiments, the state signal further comprises at least one expected future position and at least one expected future velocity of the second autonomous mobile robot, and the method comprises operating the processor of the first autonomous mobile robot to: determine the at least one predicted future position of the second autonomous mobile robot based at least on the at least one expected future position and the at least one expected future velocity of the second autonomous mobile robot.

In some embodiments, the state signal further comprises mission information of the second autonomous mobile robot, the mission information comprising one or more of a mission type of the second autonomous mobile robot, a trajectory of the second autonomous mobile robot, a destination of the second autonomous mobile robot and a priority of the mission and the method further comprises operating the processor of the first autonomous mobile robot to modify the trajectory of the first autonomous mobile robot based on the mission information.

In some embodiments, the state signal comprises a robot identifier of the second autonomous mobile robot, and the method further comprises operating the processor of the first autonomous mobile robot to: retrieve, from a data storage, dimensions of a load of the second autonomous mobile robot based on the robot identifier; and determine the risk of collision based on the dimensions of the load of the second autonomous mobile robot.

In some embodiments, the state signal comprises a distance of the second autonomous mobile robot to a landmark within the facility and the method further comprises operating the processor of the first autonomous mobile robot to: update a localization information of the first autonomous mobile robot based on the distance of the second autonomous mobile robot to the landmark and a signal strength of the state signal.

### BRIEF DESCRIPTION OF THE DRAWINGS

Several embodiments will now be described in detail with reference to the drawings, in which:

FIG. 1 is a block diagram of example autonomous mobile robots in communication with external components, according to an example embodiment;

FIG. 2 is a block diagram of example components of an example autonomous mobile robot, according to an example embodiment;

FIG. 3 is another block diagram of example components of the autonomous mobile robot of FIG. 2;

FIG. 4 is a flowchart of an example method for collision avoidance for autonomous mobile robots using short-range position sharing, in accordance with an example embodiment;

FIG. 5 is a block diagram showing communication channels between autonomous mobile robots and a fleet management system, according to an example embodiment;

FIG. 6 is a schematic diagram of example autonomous mobile robots operating in a facility according to an example embodiment;

FIG. 7A is a schematic diagram of other example autonomous mobile robots operating in a facility, at a first time, according to an example embodiment;

FIG. 7B is a schematic diagram of the example autonomous mobile robots operating in the facility, at a second time;

FIG. 8 is a flowchart of another example method for collision avoidance for autonomous mobile robots using short-range position sharing, in accordance with an example embodiment; and

FIG. 9 is a flowchart of another example method for collision avoidance for autonomous mobile robots using short-range position sharing, in accordance with an example embodiment;

The drawings, described below, are provided for purposes of illustration, and not of limitation, of the aspects and features of various examples of embodiments described herein. For simplicity and clarity of illustration, elements shown in the drawings have not necessarily been drawn to scale. The dimensions of some of the elements may be exaggerated relative to other elements for clarity. It will be appreciated that for simplicity and clarity of illustration, where considered appropriate, reference numerals may be repeated among the drawings to indicate corresponding or analogous elements or steps.

### DESCRIPTION OF EXAMPLE EMBODIMENTS

The various embodiments described herein generally relate to systems and method for collision avoidance for autonomous mobile robots operating within a facility using short-range position sharing.

Collision avoidance is key to safely operating autonomous mobile robots. Generally, autonomous mobile robots use external sensors to detect objects that may present a risk of collision (i.e., obstacles). If an autonomous mobile robot detects an object within its pre-defined safety boundary, the autonomous mobile robot typically comes to a stop, to minimize the potential of a collision event. In some cases, the autonomous mobile robot can also modify its planned path, to avoid the obstacle.

Autonomous mobile robots can operate as material transport robots and transport loads between different waypoints. In some cases, the load transported by the autonomous mobile robots can have a footprint that is larger than the footprint of the autonomous mobile robot, causing parts of the load to overhang.

External sensors used to detect objects are typically located on the body of the autonomous mobile robot have a field of view that is suited for detecting obstacles that are located near the ground or floor surface. However, due to their location, these sensors can fail to detect obstacles that are located at a distance from the ground or floor, such as overhanging loads, which can cause autonomous mobile robots to collide with loads carried by other autonomous mobile robots or can cause loads carried by different autonomous mobile robots to collide.

To improve autonomous mobile robots'ability to detect obstacles that are located partly or wholly outside the field of view of external sensors, existing techniques involve equipping autonomous mobile robots with WiFi capabilities that allow the autonomous mobile robots to continuously report their position to a fleet manager, which can then share the information to nearby autonomous mobile robots. However, WiFi technology requires modifications to the facilities to install the WiFi infrastructure and can be unreliable if the number or configuration of routers or access points installed is suboptimal for the facility. WiFi can be particularly unreliable in facilities that are constructed with or that store dense materials, such as factories or warehouses. An unstable connection can cause autonomous mobile robots to lose connection with the fleet manager which, in cases where autonomous mobile robots rely on the fleet manager for navigation, can result in the autonomous mobile robot coming to a stop until connection is reestablished or until an operator manually intervenes, causing autonomous mobile robots to operate inefficiently.

To improve detection of obstacles and augment the capabilities of existing sensors positioned on the body of autonomous mobile robots, the disclosed systems and methods use short-range communication to share state information including position information between the autonomous mobile robots. The disclosed systems and methods can allow autonomous mobile robots to reliably communicate with each other without the use of base stations. As will be described, by transmitting state information using short-range communication, only those autonomous mobile robots that may be at risk of collision receive the state information, reducing the reception of information about other autonomous mobile robots that is not relevant.

The disclosed systems and methods can involve a first autonomous mobile robot first broadcasting a low power presence signal and detecting autonomous mobile robots that are within the vicinity of the first autonomous mobile robot and then transmitting information about its current and future state to autonomous mobile robots that are within its vicinity. By first broadcasting a low power presence signal that consumes little power and network resources, the first autonomous mobile robot can avoid using network resources to transmit information about its state if no autonomous mobile robot is in its vicinity.

When an autonomous mobile robot receives information about the state of another autonomous mobile robot, the first autonomous mobile robot can determine whether its future position is likely to cause a risk of collision with the other autonomous mobile robot and modify its path accordingly to avoid the risk of collision.

In some embodiments, the systems and methods described can be used in combination with conventional WiFi systems and can be used to augment the capabilities of WiFi systems. For example, in some embodiments, the described systems and methods can be employed when an autonomous mobile robot loses connectivity to the WiFi network or when the WiFi connectivity becomes unstable.

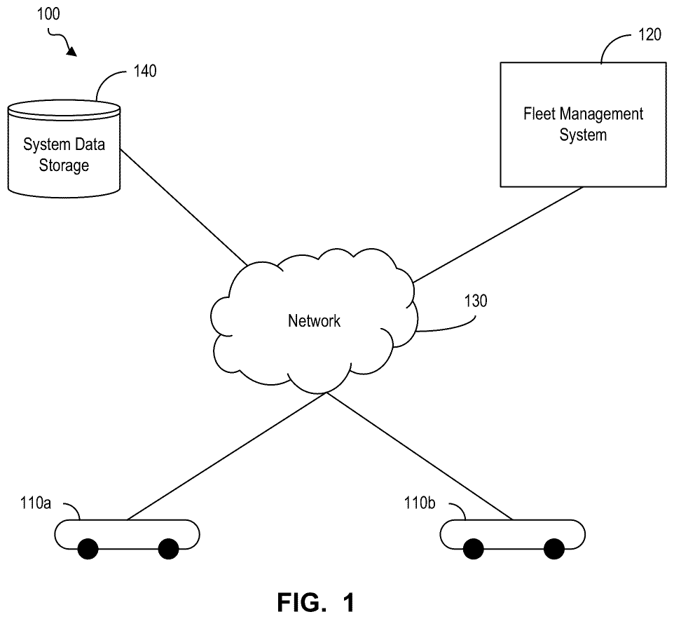

Referring now to FIG. 1, shown therein a block diagram 100 illustrating example autonomous mobile robots 110 in communication with example external components. As shown in FIG. 1, the autonomous mobile robots 110 can be in communication with a fleet management system 120 and a system data storage 140 via a network 130. The autonomous mobile robots 110 can operate to pick up, transport, and/or drop off materials at various locations.

The network 130 may be any network capable of carrying data, including the Internet, Ethernet, old telephone service (POTS) line, public switch telephone network (PSTN), integrated services digital network (ISDN), digital subscriber line (DSL), coaxial cable, fiber optics, satellite, mobile, wireless (e.g. Wi-Fi™, WiMAX®), Signaling System 7 (SS7) network, fixed line, local area network (LAN), wide area network (WAN), and others, including any combination of these, capable of interfacing with, and enabling communication between the autonomous mobile robots 110, the fleet management system 120 and/or the system data storage 140. In some embodiments, the autonomous mobile robot 110 can communicate with other robots via the network 130. In some embodiments, the autonomous mobile robot 110 can communicate with other autonomous mobile robots directly via onboard communication components.

The system data storage 140 can store data related to the autonomous mobile robots 110 and/or the fleet management system 120. The system data storage 140 can include RAM, ROM, one or more hard drives, one or more flash drives or some other suitable data storage elements such as disk drives, etc.

The system data storage 140 can also store electronic maps related to the operating environment of the autonomous mobile robot 110. The electronic maps located on system data storage 140 can be accessible for download, via the network 130, by the fleet management system 120 and the mobile robot 110. In some embodiments, the electronic map can be generated and updated by the fleet management system 120 based on information received from the autonomous mobile robot 110. In some embodiments, the system data storage 140 can be located at the fleet management system 120.

The illustrated FIG. 1 includes the fleet management system 120. The fleet management system 120 can operate to direct and/or monitor the operation of the autonomous mobile robot 110. In some embodiments, the mobile robot 110 can operate within a decentralized network—without, or at least with minimal, involvement of the fleet management system 120.

The fleet management system 120 can include a processor, a data storage, and a communication component (not shown). For example, the fleet management system 120 can be any computing device, such as, but not limited to, an electronic tablet device, a personal computer, workstation, server, portable computer, mobile device, personal digital assistant, laptop, smart phone, WAP phone, an interactive television, video display terminals, gaming consoles, and portable electronic devices or any combination of these. The components of the fleet management system 120 can be provided over a wide geographic area and connected via the network 130.

The processor of the fleet management system 120 can include any suitable processors, controllers or digital signal processors that can provide sufficient processing power depending on the configuration, purposes and requirements of the fleet management system 120. In some embodiments, the processor can include more than one processor with each processor being configured to perform different dedicated tasks.

The data storage of the fleet management system 120 can include random access memory (RAM), a read-only memory (ROM), an erasable programmable read-only memory (EPROM, EEPROM, or Flash memory), one or more hard drives, one or more flash drives or some other suitable data storage elements such as disk drives, etc. The communication component of the fleet management system 120 can include any interface that enables the fleet management system 120 to communicate with other devices and systems. In some embodiments, the communication component can include at least one of a serial port, a parallel port or a USB port. The communication component may also include at least one of an Internet, Local Area Network (LAN), Ethernet, Firewire, modem or digital subscriber line connection. Various combinations of these elements may be incorporated within the communication component. For example, the communication component may receive input from various input devices, such as a mouse, a keyboard, a touch screen, a thumbwheel, a track-pad, a track-ball, a card-reader, voice recognition software and the like depending on the requirements and implementation of the fleet management system 120.

In some embodiments, the fleet management system 120 can generate commands or missions for the autonomous mobile robots 110. For example, the fleet management system 120 can generate and transmit navigational commands to the autonomous mobile robot 110. The navigational commands can direct the autonomous mobile robot 110 to navigate to one or more waypoints or destination locations located within the operating environment of the autonomous mobile robot 110. For example, the destination locations can correspond to locations where the autonomous mobile robot 110 is required to pick up or drop off loads.

In some embodiments, the fleet management system 120 can transmit the destination locations to the autonomous mobile robot 110 and the autonomous mobile robot 110 can then navigate itself to the waypoints or destination locations. The fleet management system 120 can transmit the destination locations in various formats, such as, but not limited to, a set of Global Positioning System (GPS) coordinates, or coordinates defined relative to an electronic map accessible to the autonomous mobile robot 110 and the fleet management system 120. The destination locations, in some embodiments, can be identified with respect to known objects or landmarks within the operating environment of the autonomous mobile robot 110. For example, the autonomous mobile robot 110 can identify the location of the object or landmark on an electronic map, and navigate to the object or landmark. In some embodiments, the object or landmark can relate to a visual target.

In some embodiments, the fleet management system 120 can transmit information about one or more other autonomous mobile robots 110 to the autonomous mobile robot 110. For example, the fleet management system 120 can transmit information about a size and/or shape of another autonomous mobile robot 110, a load carried (e.g., dimensions of the load) by another autonomous mobile robot 110, and/or information about missions executed by other autonomous mobile robots 110.

The fleet management system 120 can also receive data from the autonomous mobile robot 110. For example, the autonomous mobile robot 110 can transmit operating data about objects identified during its operation that appear inconsistent with the electronic map. The fleet management system 120 can receive the operating data and update the electronic map, as necessary.

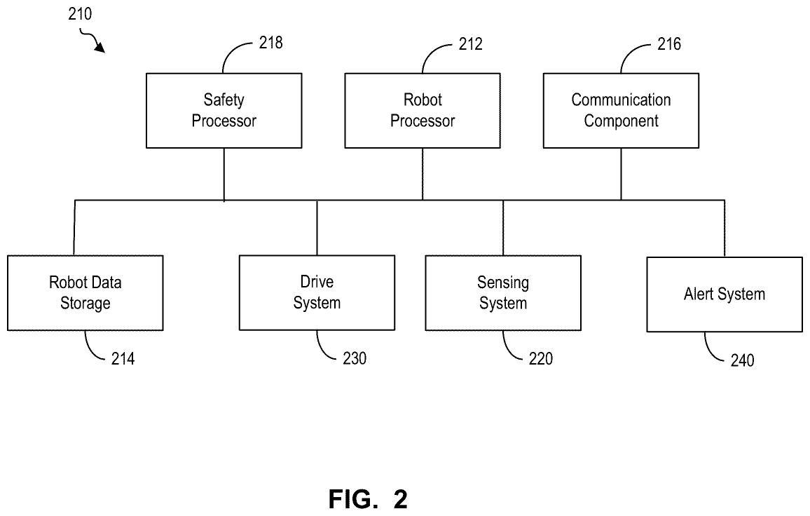

Reference is next made to FIG. 2, which illustrates a schematic diagram showing an example embodiment of an autonomous mobile robot 210. Specifically, autonomous mobile robot 210 can act as an autonomous robot for transporting objects between different locations. The autonomous mobile robot 210 can include a cargo component for carrying loads. For example, the cargo component can be a flatbed or a bucket having sidewalls to prevent loads from falling out as the autonomous mobile robot 210 moves. The cargo component can extend over the sides of the autonomous mobile robot 210 (i.e., the cargo component can have a larger footprint than the autonomous mobile robot 210). The autonomous mobile robot 210 can include cargo securing mechanisms to secure the load and prevent the load from falling off the autonomous mobile robot 210. The autonomous mobile robot 210 can include flexible components, which may be removed from the autonomous mobile robot 210. For example, a cargo securing mechanism may be removable when not in use. Although the autonomous mobile robot 210 can act as a transport robot, the autonomous mobile robot 210 is not limited to transporting objects.

The autonomous mobile robot 210 can include a vehicle processor 212, a vehicle data storage 214, a communication component 216, a safety processor 218, a sensing system 220, a drive system 230 and an alert system 240. In some embodiments, one or more of the components 212, 214, 216, 218, 220, 230 and 240 can be combined into fewer components, or separated into further components. For example, the vehicle processor 212 and the safety processor 218 can be combined in the same component. In some embodiments, parts of a component can be combined with another part of another component.

The vehicle processor 212 and the safety processor 218 can each include any suitable processor, controller or digital signal processor that can provide sufficient processing power and reliability depending on the configuration, purposes and requirements of the autonomous mobile robot 210. In some embodiments, the vehicle processor 212 and the safety processor 218 can each include more than one processor with each processor being configured to perform different dedicated tasks.

The vehicle processor 212 may be operable to navigate the autonomous mobile robot 210 in response to one or more of: a navigation command and an operational signal. The autonomous mobile robot 210 may be an autonomous mobile robot 110. The navigation command may be a command to navigate the autonomous mobile robot 210 to a specified waypoint. The operational signal may, in some instances, be a command to stop or slow the autonomous mobile robot 210.

The vehicle processor 212 and the safety processor 218 can each operate the vehicle data storage 214, the communication component 216, the sensing system 220, and the drive system 230. For example, the vehicle processor 212 and the safety processor 218 can each operate the drive system 230 to navigate to the waypoints or destination location as identified by a fleet management system. The vehicle processor 212 and the safety processor 218 can each also operate the drive system 230 to avoid collisions with objects detected in the autonomous mobile robot's proximity and bring the autonomous mobile robot to a stop, or rest position. The safety processor 218 can operate the alert system 240 to generate alerts. The operation of the vehicle processor 212 and the safety processor 218 can each be based on data collected from the robot data storage 214, the communication component 216, the sensing system 220, and/or the drive system 230, in some embodiments.

Given waypoints or a destination location, the vehicle processor 212 can determine a trajectory to the destination location. A trajectory can be defined as a time-parameterized path and a path can be defined based on a series of positions, which may or may not include headings. Different trajectories can relate to the same path as an autonomous mobile robot may follow the same path but at different speeds.

The vehicle data storage 214 can include RAM, ROM, one or more hard drives, one or more flash drives or some other suitable data storage elements such as disk drives, etc. For example, the robot data storage 214 can include volatile and non-volatile memory. Non-volatile memory can store computer programs consisting of computer-executable instructions, which can be loaded into the volatile memory for execution by the vehicle processor 212 or the safety processor 218. Operating the vehicle processor 212 to carry out a function can involve executing instructions (e.g., a software program) that can be stored in the vehicle data storage 214 and/or transmitting or receiving inputs and outputs via the communication component 216. The vehicle data storage 214 can also store data input to, or output from, the vehicle processor 212 or the safety processor 218, which can result from the course of executing the computer-executable instructions for example.

In some embodiments, the vehicle data storage 214 can store data related to the operation of the autonomous mobile robot 210, such as one or more electronic maps of its operating environment and/or operating parameters. The vehicle data storage 214 can store data tables, data processing algorithms (e.g., image processing algorithms), as well as other data and/or operating instructions which can be used by the vehicle processor 212 or the safety processor 218. The vehicle processor 212 and the safety processor 218 can each operate to process data received from the sensing system 220.

In some embodiments, the vehicle data storage 214 can store data about one or more other autonomous mobile robots 210, received from the fleet management system 120. For example, the vehicle data storage 214 can store information about a size or shape of an autonomous mobile robot 210, a size or shape (e.g., dimensions) of a load carried by an autonomous mobile robot 210 and/or information about a mission executed by an autonomous mobile robot 210, in association with robot identification information.

In some embodiments, the vehicle data storage 214 can store data about one or more other autonomous mobile robots 210 received from one or more other autonomous mobile robots 210 (e.g., contents of state signals).

The communication component 216 can include any interface that enables the autonomous mobile robot 210 to communicate with other components, external devices and systems and other autonomous mobile robots 210. The communication component 216 can include a short-range wireless communication transmitter, receiver or transceiver for directly communicating with other autonomous mobile robots 210. The short-range communication protocol used by the transmitter, receiver or transceiver can be any short-range communication protocol that enables autonomous mobile robots 210 to reliably communicate with each other without the use of an external base station, including but not limited to, Bluetooth Low Energy (BLE), Z-Wave, Zigbee, Mesh Wi-Fi, or any other radio wave communication protocol.

In some embodiments, the communication component 216 can include at least one of a serial port, a parallel port or a USB port. The communication component 216 may also include a wireless transmitter, receiver, or transceiver for communicating with a wireless communications network (e.g., using an IEEE 802.11 protocol or similar) over a wider area than the short-range wireless communication protocol used for communicating information between autonomous mobile robots 210. The wireless communications network can include at least one of an Internet, Local Area Network (LAN), Ethernet, Firewire, modem or digital subscriber line connection and can be used by the autonomous mobile robot 210 to communicate with the fleet management system 120 and/or to communicate information to other autonomous mobile robots 210 that does not require the same level of reliability as the short-range wireless communication described above.

Various combinations of these elements may be incorporated within the communication component 216. For example, the communication component 216 may also be used to receive input from various input devices, such as a mouse, a keyboard, a touch screen, a thumbwheel, a track-pad, a track-ball, a card-reader, voice recognition software and the like depending on the requirements and implementation of the autonomous mobile robot 210. For example, the communication component 216 can receive commands and/or data from the computing device 120 and/or another autonomous mobile robot (e.g., another autonomous mobile robot operating within the operating environment).

The communication component 216 can receive information about obstacles and/or unexpected objects located in the autonomous mobile robot's operating environment directly from other autonomous mobile robots within the same operating environment and/or indirectly via a fleet management system. The vehicle processor 212 can update an electronic map stored in the vehicle data storage 214 with this information, for example. The vehicle processor 212 may also transmit, via the communication component 216 for example, information related to obstacles and/or unexpected objects identified in its operating environment to other autonomous mobile robots directly or indirectly via the fleet management system.

The sensing system 220 can monitor the environment of the autonomous mobile robot 210. The sensing system 220 can include one or more vehicle sensors for capturing information related to the environment. The information captured by the sensing system 220 can be applied for various purposes, such as localization, navigation, mapping and/or collision avoidance. For example, the sensing system 220 can include optical sensors equipped with depth perception capabilities, infrared (IR) capabilities, or sonar capabilities. The optical sensors can include imaging sensors (e.g., photographic and/or video cameras), and range-finding sensors (e.g., time of flight sensors, Light Detection and Ranging (LiDAR) devices which generate and detect reflections of pulsed laser from objects proximal to the autonomous mobile robot 210, etc.). The sensing system 220 can also include navigational sensors, such as global positioning system (GPS) sensors, as well as sensors that detect guiding infrastructure installed within the operating environment. Example sensors that detect guiding infrastructure can include, but not limited to, magnetic sensors that detect magnetic tape within a facility warehouse, and/or optical sensors that detect visual navigational indicators within the operating environment. The sensing system 220 can include proximity sensors that detect people or objects within a proximity of the autonomous mobile robot 210.

The sensing system 220 may comprise at least one vehicle sensor operable to detect a triggering event and generate an operational signal in response to detecting the triggering event. The triggering event may be any event in which it is desirable for the autonomous mobile robot 210 to immediately react to. The operational signal may comprise any signal that is desirable for the sensing system 220 to generate in response to detecting the triggering event for the purposes of alerting other components. For example, the triggering event may comprise an event in which a proximity sensor detects a person or object within the proximity of the autonomous mobile robot 210. As another example, the trigger event may comprise an event in which an optical sensor, such as a LiDAR sensor, generates a detection such that there is a possibility of an obstacle being in proximity to the autonomous mobile robot 210. In response, an example operational signal may include a command to apply emergency braking. For example, a ‘high’ voltage or a ‘1’ bit could be sent to an input terminal dedicated to monitoring safety braking events.

The sensing system 220 can also monitor the operation of the autonomous mobile robot 210. The sensing system 220 can include example sensors, such as encoders, arranged to measure the speed of a wheel of the autonomous mobile robot 210, the traction of the autonomous mobile robot 210, or the tilt angle of the autonomous mobile robot 210. In some embodiments, encoders are provided for each wheel. On tricycle autonomous mobile robots, encoders can measure the steering angle along with the drive velocity. The sensing system 220 can include sensors to measure the presence, the mass, or the type of a payload of the autonomous mobile robot 210.

The sensing system 220 can include a vehicle odometry system to monitor continuous variables and/or discrete variables. For example, continuous variables can relate to speed, velocity, traction, steering angle, tilt angle, and/or payload mass measurements while discrete variables can relate to the presence of a payload, the type of payload, and/or the presence of a human within a proximity of the autonomous mobile robot 210.

The sensing system 220 can include one or more components that control the operation of the sensors. For example, the components can include, but is not limited to, one or more processors, programmable logic controllers (PLCs), motor contactors, and/or relays. In some embodiments, the sensing processors can receive data collected by the sensors and process the collected data. The sensing processors can operate independently from the vehicle processor 212 and the safety processor 218. In some embodiments, the sensing system 220 can receive the data collected by the sensors and transmit the collected data to the vehicle processor 212 and the safety processor 218 for processing. In other embodiments, the sensing system 220 can directly incorporate functionality from the safety processor 218.

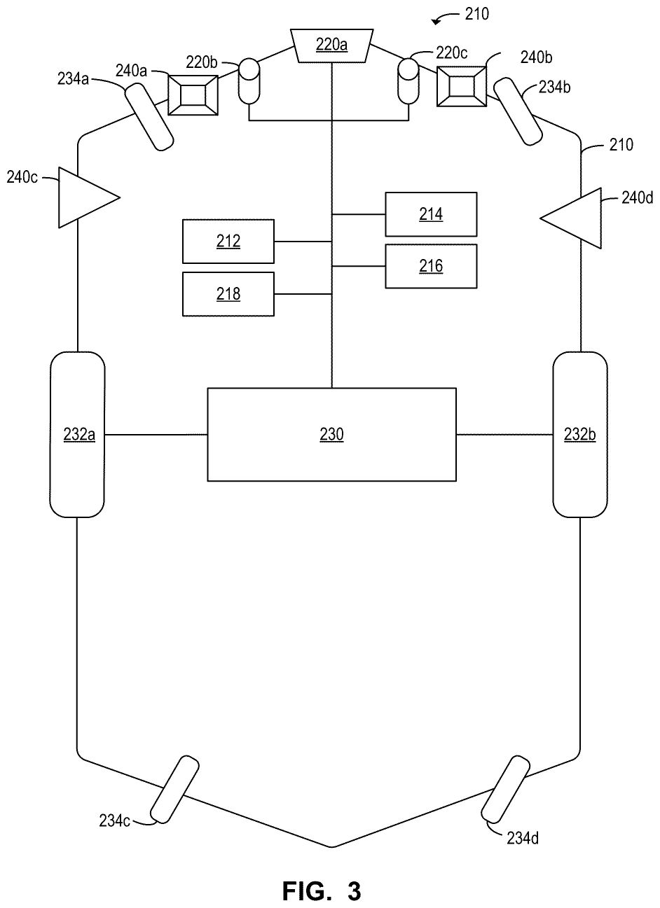

The drive system 230 can include the components required for steering and driving the autonomous mobile robot 210. For example, the drive system 230 can include the steering component and drive motor. Specifically, the drive system 230 may include a motor and/or brakes connected to drive wheels 232a and 232b for driving the autonomous mobile robot 210, as shown in FIG. 3. The motor can be, but is not limited to, an electric motor, a combustion engine, or a combination/hybrid thereof. Depending on the application of the autonomous mobile robot 210, the drive system 230 may also include control interfaces that can be used for controlling the drive system 230. For example, the drive system 230 may be controlled to drive the drive wheel 232a at a different speed than the drive wheel 232b in order to turn the autonomous mobile robot 210. Different embodiments may use different numbers of drive wheels, such as two, three, four, etc.

As shown in FIG. 3, a number of additional wheels 234 may be included. The autonomous mobile robot 210 includes wheels 234a, 234b, 234c, and 234d. The wheels 234 may be wheels that are capable of allowing the autonomous mobile robot 210 to turn, such as castors, omni-directional wheels, and mecanum wheels. In some embodiments, the autonomous mobile robot 210 can be equipped with special tires for rugged surfaces or particular floor surfaces unique to its environment.

The sensing system 220 in FIG. 2 includes example vehicle sensors 220a, 220b, and 220c, as shown in FIG. 3. The sensors 220a, 220b, 220c can include, but are not limited to, optical sensors arranged to provide three-dimensional (e.g., binocular or RGB-D) imaging, two-dimensional laser scanners, and three-dimensional laser scanner.

The alert system 240 can include components that can generate visual and/or auditive alerts to notify human operators or other autonomous mobile robots 210 of the presence of an autonomous mobile robot 210. For example, the alert system 240 can include lights and/or speakers.

The positions of the components 234, 220, 240, 230, 232, 240 of the autonomous mobile robot 210 is shown for illustrative purposes and are not limited to the illustrated positions. Other configurations of the components 234, 220, 240, 230, 232 can be used depending on the application of the autonomous mobile robot 210 and/or the environment in which the autonomous mobile robot 210 will be used.

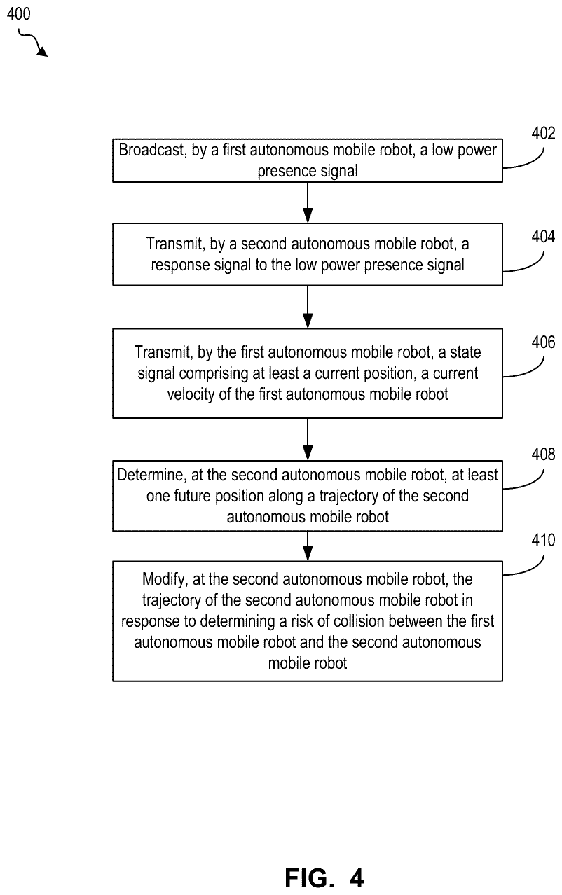

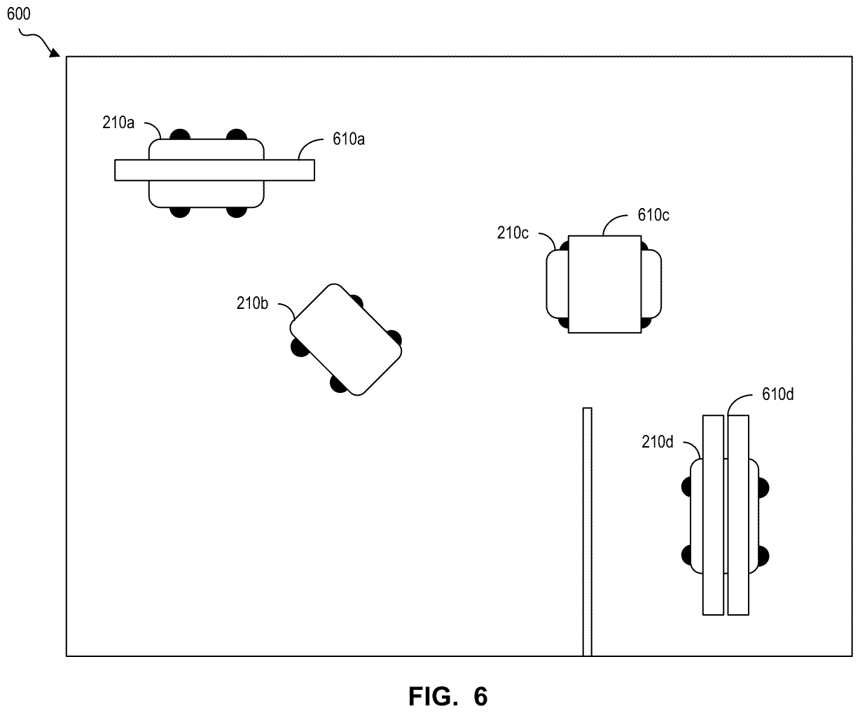

Reference is now made to FIG. 4, which shows a flowchart illustrating an example method 400 for collision avoidance for autonomous mobile robots 210 using short-range position sharing. The method can be used to augment the sensing capabilities of autonomous mobile robots 210. As shown in FIG. 6, which shows a schematic diagram 600 of autonomous mobile robots 210 operating in a facility, various autonomous mobile robots 210a, 210b, 210c, 210d carrying various loads 610 can operate within a facility. As shown, in some cases, the load 610 carried by an autonomous mobile robot 210 can extend over the body of the autonomous mobile robot, causing the load to overhang.

At 402, the communication component 216 of the autonomous mobile robot 210a broadcasts a low power signal using a short-range communication protocol to indicate its presence within the facility. The signal can be a low power signal that requires limited network resources and that is sufficient strength to be detected by other autonomous mobile robots 210 or other vehicles or equipment capable of detecting short-range signals. By broadcasting the low power presence signal, the autonomous mobile robot 210a can discover nearby autonomous mobile robots 210a without requiring a connection to be first established between the autonomous mobile robots 210.

The short-range communication protocol can be any unidirectional short-range communication protocol that allows the autonomous mobile robot 210a to broadcast information without the use of a base station and without first requiring the autonomous mobile robot 210a to establish a connection with other autonomous mobile robots 210. For example, the short-range communication protocol can include but is not limited to, Bluetooth Low Energy (BLE), Z-Wave, Zigbee, Mesh Wi-Fi, or any other radio wave communication protocol.

The low power presence signal can be transmitted at a constant rate or can be transmitted at a varying rate. For example, in some embodiments, the rate of transmission of the low power presence signal can vary based on the current velocity of the autonomous mobile robot. For example, an autonomous mobile robot 210 that is in a stationary position can broadcast the low power presence signal at a lower rate than an autonomous mobile robot 210 that is traveling. As another example, an autonomous mobile robot that is traveling at a higher speed can transmit low power presence signals at a higher rate than an autonomous mobile robot 210 that is traveling at a lower speed since its position varies more rapidly

In some embodiments, the rate of transmission of the low power presence signal can vary based on the number or density of nearby autonomous mobile robots 210. For example, the autonomous mobile robot 210a can transmit the low power presence signal at a higher rate when the number of nearby autonomous mobile robots 210 is high.

In some embodiments, the rate of transmission of the low power presence signal can vary in response to changes in the autonomous mobile robot's 210 mission, or trajectory. For example, a change in the autonomous mobile robot's 210a trajectory and/or heading can cause the autonomous mobile robot 210a to transmit the low power presence signal prior to the next scheduled transmission.

In some embodiments, the rate of transmission of the low power presence signal can vary based on the type of facility. For example, facilities employing slow moving autonomous mobile robots 210 may require a lower rate of transmission than facilities employing nimble or fast-moving autonomous mobile robots 210. As another example, facilities in which autonomous mobile robots 210 are more likely to transport overhanging loads may require a higher rate of transmission than facilities in which autonomous mobile robots 210 are unlikely to transport overhanging loads.

In some embodiments, the rate of transmission of the low power presence signal can vary based on the network resources available to minimize interference between the various autonomous mobile robots 210 broadcasts. For example, the autonomous mobile robot 210a can determine that its rate of transmission interferes with or is likely to interfere with signals broadcasted by other autonomous mobile robots 210 and adjust its rate of transmission to minimize interference (e.g., reduce its rate of transmission). Similarly, in some embodiments, the rate of transmission of the low power presence signal can vary based on ambient electromagnetic interference.

In some embodiments, the autonomous mobile robot 210a can additionally generate alerts using the alert system 240. For example, the autonomous mobile robot 210a can generate a visual alert through flashing lights and/or can generate auditive alerts.

Autonomous mobile robots 210 located within the range of the short-range communication protocol can detect the low power presence signal transmitted. For example, autonomous mobile robot 210b, shown in FIG. 6, can be located at a distance from autonomous mobile robot 210a that is within the range of the communication protocol and can detect the broadcasted signal.

At 404, autonomous mobile robot 210b can transmit a response signal in response to the signal broadcasted by autonomous mobile robot 210a when autonomous mobile robot 210b detects the low power presence signal. The autonomous mobile robot 210b can transmit a response signal using the communication component 216 of the autonomous mobile robot 210b.

At 406, in response to detecting the response signal transmitted by autonomous mobile robot 210b, autonomous mobile robot 210a transmits to autonomous mobile robot 210b a state signal. The state signal can be a signal that requires more network resources when compared to the low power presence signal. The state signal can be transmitted using the same short-range communication protocol as the presence signal or can be transmitted using another short-range communication protocol. For example, the state signal can be transmitted via a short-range communication protocol that is suitable for transmitting more information that the short-range communication used for transmitting the presence signal.

In some embodiments, the autonomous mobile robot 210a can validate the response signal with sensor data and/or information received from the fleet management system 120 and only transmit the state signal if the sensor data and/or the fleet management system 120 indicate the presence of the autonomous mobile robot 210b.

The state signal can include information about the current state of the autonomous mobile robot 210a and in some embodiments, the expected future state of the autonomous mobile robot 210a. For example, state information can include a position of the autonomous mobile robot 210a a current velocity, an expected future position and an expected future velocity of the autonomous mobile robot 210a. The expected future position and expected future velocity can include timing information associated with the expected future position and expected future velocity. The precision and/or resolution of the state signal can vary, depending on the short-range communication protocol used. In some embodiments, to reduce the amount of information transmitted, the autonomous mobile robot 210a can transmit a reduced resolution state signal, for example, in cases where the position and/or velocity of the autonomous mobile robot 210a is constrained within a pre-determined range and the autonomous mobile robot 210b can determine the actual position and/or velocity of the autonomous mobile robot 210a based on the pre-determined range.

In some embodiments, the expected future position and expected future velocity can include the future position and future velocity of the autonomous mobile robot 210a at two or more future times. For example, the expected future position can include the expected future position at times t₁, t₂ occurring in the immediate future, and t₃, occurring in the intermediate to distant future. The precision and/or resolution of the expected future position at times t₁ and t₂ can be higher than the expected future position at time t₃. In such embodiments, the autonomous mobile robot 210b can store all expected future positions and expected future velocities, for example, in robot data storage 214.

In some embodiments, immediate expected future positions and immediate expected future velocities and intermediate to distant expected future positions and intermediate to distant expected future velocities can be transmitted at different rates. For example, immediate expected future positions and immediate expected future velocities can be transmitted at a higher rate.

In some embodiments, the state signal includes a robot identifier that identifies the autonomous mobile robot 210a. As described, the fleet management system 120 can transmit information to autonomous mobile robot 210 about other autonomous mobile robots 210, including, for example, information about a size and shape of an autonomous mobile robot 210, a size and shape of a load carried by an autonomous mobile robot 210 and/or information about a mission executed by an autonomous mobile robot 210, in association with a robot identifier identifying the autonomous mobile robot 210. Using the robot identifier, the autonomous mobile robot 210b can retrieve information about autonomous mobile robot 210a.

In some embodiments, the state signal includes information about the load carried by autonomous mobile robot 210a. As explained, autonomous mobile robot 210a can be a material-transport robot that carries an overhanging load. The state signal can include information about the size and shape of the load, which can be used by autonomous mobile robot 210b to determine a risk of collision, as will be explained in further detail below in reference to step 410.

In some embodiments, the state signal additionally includes information about the mission of the autonomous mobile robot 210a, for example, the priority of the mission, the destination, the trajectory, or the type of mission. The state signal can additionally include information about whether the autonomous mobile robot 210a is adhering to its trajectory and other characteristics of the autonomous mobile robot 210 including a measure of nimbleness of the autonomous mobile robot 210a.

In some embodiments, autonomous mobile robot 210b can use the information contained in the state signal to aid in its localization. For example, the state signal can include information about the distance between autonomous mobile robot 210a and one or more landmarks within the facility. The autonomous mobile robot 210b can determine its position relative to the landmark based on the location of the autonomous mobile robot 210a relative to the landmark and the signal strength of the state signal and compare the determined location with an expected location. The autonomous mobile robot 210b can then update its electronic map if there is a discrepancy between the determined location and the expected location and/or update its localization information. For example, overtime, as the autonomous mobile robot 210b travels within the facility, odometry errors may cause the actual position of the autonomous mobile robot 210b to differ from the expected position. Using the information contained in the state signal, the autonomous mobile robot 210b can update its localization information to minimize or correct odometry errors.

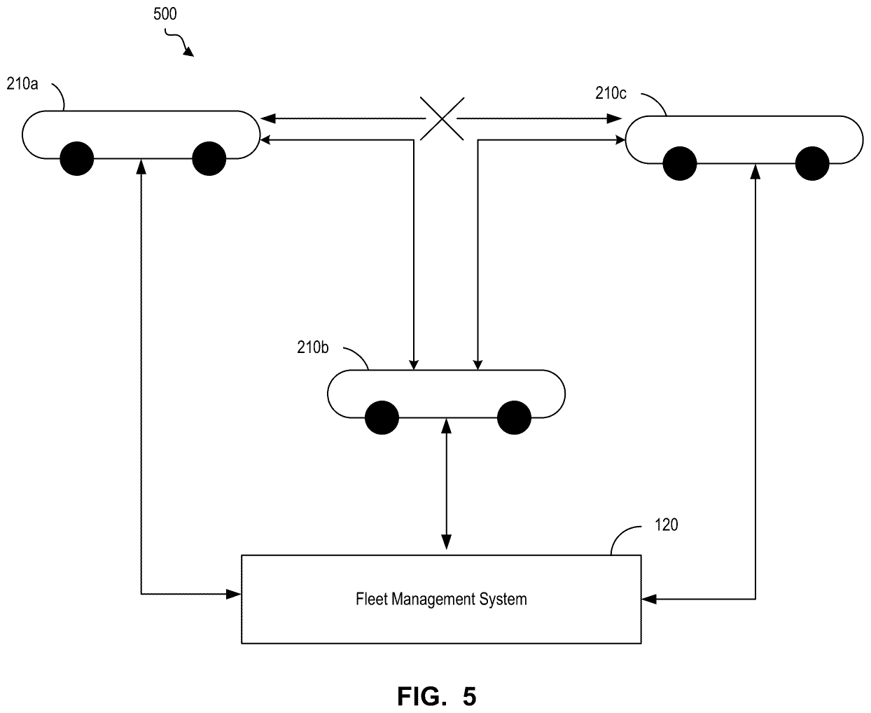

In some embodiments, the autonomous mobile robot 210b can relay the contents of the state signal received from autonomous mobile robot 210a to one or more additional autonomous mobile robots 210. For example, as shown in FIG. 5, autonomous mobile robot 210c can be located at a distance from autonomous mobile robot 210a that is outside the range of communication of the short-range communication protocol. In such cases, autonomous mobile robot 210c can receive information about autonomous mobile robot 210a via autonomous robot 210b, which can retransmit the state signal received from autonomous mobile robot 210a to autonomous mobile robot 210c or transmit a state signal that includes the contents of the state signal received from autonomous mobile robot 210a. In some embodiments, the autonomous mobile robot 210b can transmit a state signal that includes its state information and the state information of the autonomous mobile robot 210a. Similarly, autonomous mobile robot 210a can receive information about autonomous mobile robot 210c via autonomous mobile robot 210b.

At 408, autonomous mobile robot 210b determines at least one future position along its trajectory. For example, the vehicle processor 212 of autonomous mobile robot 210b can determine at least one future position of the autonomous mobile robot 210b at given times t based on the trajectory to the destination location of the autonomous mobile robot 210b previously determined by the vehicle processor 212. Alternatively, the autonomous mobile robot 210b can determine at least one future position based on its current position, current velocity and expected future velocity.

At 410, autonomous mobile robot 210b modifies its trajectory in response to determining a risk of collision between autonomous mobile robot 210b and autonomous mobile robot 210a, based at least on the at least one future position of the autonomous mobile robot 210b and at least one predicted future position of the autonomous mobile robot 210a. The autonomous mobile robot 210b can determine that there is a risk of collision when autonomous mobile robot 210b and autonomous mobile robot 210a are expected to be at or near the same location at a moment in time. The at least one predicted future position of the autonomous mobile robot 210a can correspond to the expected future position included in the state signal or can correspond to at least one predicted future position at at least one other time, determined based on the contents of the state signal.

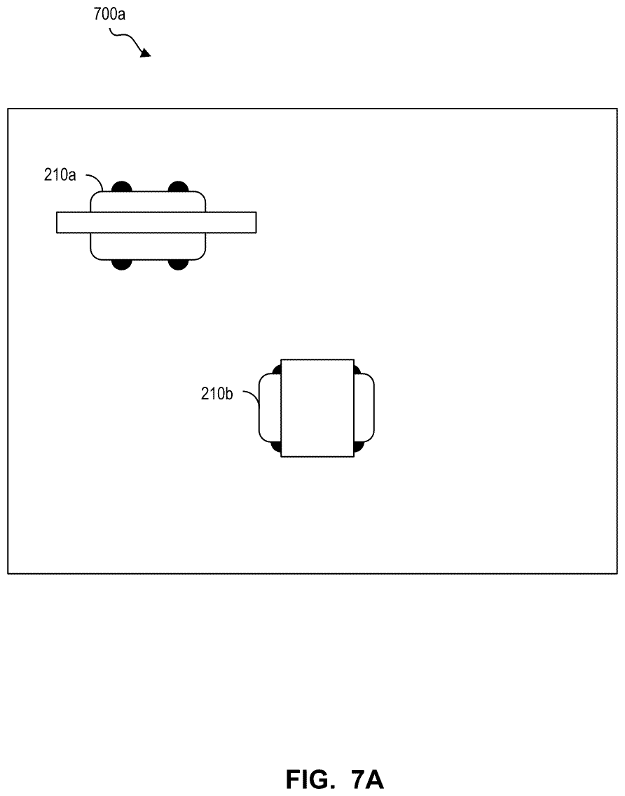

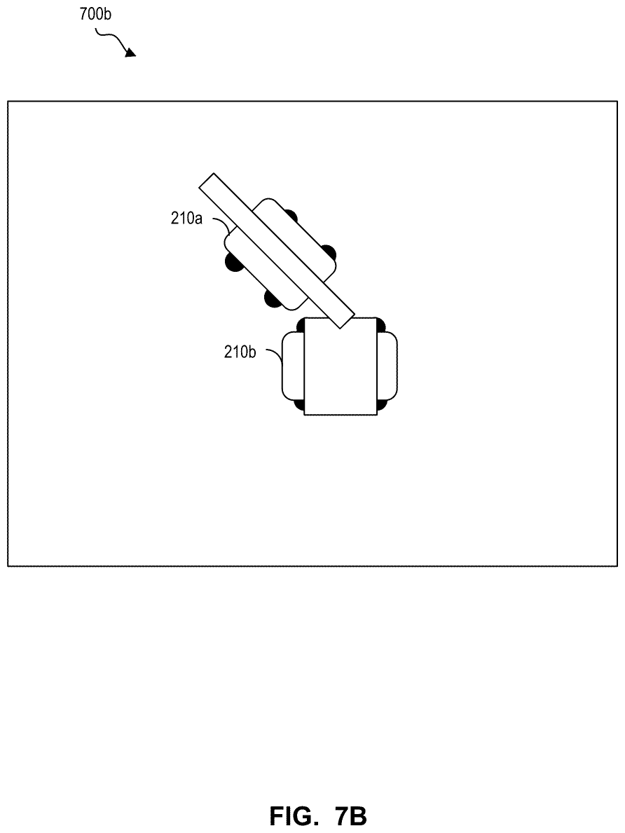

For example, as shown in FIG. 7A which illustrates a schematic diagram 700a of autonomous mobile robots 210a and 210b at a first time and FIG. 7B, which illustrates a schematic diagram 700b of a predicted future position of autonomous mobile robots 210a and 210b at a second time, autonomous mobile robot 210b can determine that there is a risk of collision.

In embodiments where the state signal does not include an expected future position of the autonomous mobile robot 210a, autonomous mobile robot 210b can determine the predicted future position of the autonomous mobile robot 210a based on the current position and current velocity of the autonomous mobile robot 210a.

In embodiments where the state signal includes two or more expected future positions and expected future velocities, the autonomous mobile robot 210b can determine at least one predicted future position of the autonomous mobile robot 210a by combining the contents of two or more state signals received from the autonomous mobile robot 210a. For example, a first state signal received from the autonomous mobile robot 210a can indicate that the autonomous mobile robot 210a is expected to be at position (x₃, y₃) at time t₃, occurring in the intermediate future. A second state signal received at a later time can indicate that the autonomous mobile robot 210a is expected to be at position (x₄, y₄), at time t₄, occurring in the immediate future. Based on the expected position at time t₃ and the expected position at time t₄, the autonomous mobile robot 210b can determine predicted future positions of the autonomous mobile robot 210a.

In embodiments where the state signal includes the trajectory of the autonomous mobile robot 210a, the at least one predicted future position can be determined based in part on the trajectory of the autonomous mobile robot 210a.

In some embodiments, the autonomous mobile robot 210b can determine a risk of collision based in part on the size and shape of the autonomous mobile robot 210a and/or the size and shape of the load carried by the autonomous mobile robot 210a, as determined by the autonomous mobile robot 210b based on the robot identifier of the autonomous mobile robot 210a, or as received by the autonomous mobile robot 210b via the state signal. For example, the autonomous mobile robot 210b can determine that autonomous mobile robot 210a requires a clearance of at least L×W, where L and W are the dimensions of the load and determine that while the autonomous mobile robot 210b is unlikely to collide with the body of the autonomous mobile robot 210a, the autonomous mobile robot 210b and/or the load carried by the autonomous mobile robot 210b is likely to collide with the load carried by the autonomous mobile robot 210a.

In embodiments where the autonomous mobile robot 210b is carrying a load, the autonomous mobile robot 210b can determine the risk of collision based in part on the size and shape of its load. For example, the autonomous mobile robot 210b can determine that it requires a clearance of L₂×W₂, where L₂ and W₂ are the dimensions of the load carried by the autonomous robot 210b and that the autonomous mobile robot 210a requires a clearance of at least L₁×W₁, where L₁ and W₁ are the dimensions of the load carried by the autonomous mobile robot 210a. Based on the dimensions of the load carried by the autonomous mobile robot 210b and the load carried by the autonomous mobile robot 210a, the autonomous mobile robot 210b can determine the risk of collision.

The robot processor 212 of mobile robot 210b can generate a modified trajectory for autonomous mobile robot 210b to avoid the risk of collision.

In some cases, autonomous mobile robot 210b can transmit a request to the fleet management system 120 for a modified trajectory and the fleet management system 120 can generate a modified trajectory for the autonomous mobile robot 210b.

In embodiments where the autonomous mobile robot 210b receives mission information for the autonomous mobile robot 210a, the autonomous mobile robot 210b can modify its trajectory based in part on the mission information of autonomous mobile robot 210a. For example, if the mission executed by autonomous mobile robot 210a is a high priority mission, the autonomous mobile robot 210b can pause and wait for the autonomous mobile robot 210a to move to a location where the autonomous mobile robot 210a no longer poses a risk of collision before resuming navigation. Alternatively, the autonomous mobile robot 210b can modify its path to avoid the autonomous mobile robot 210a.

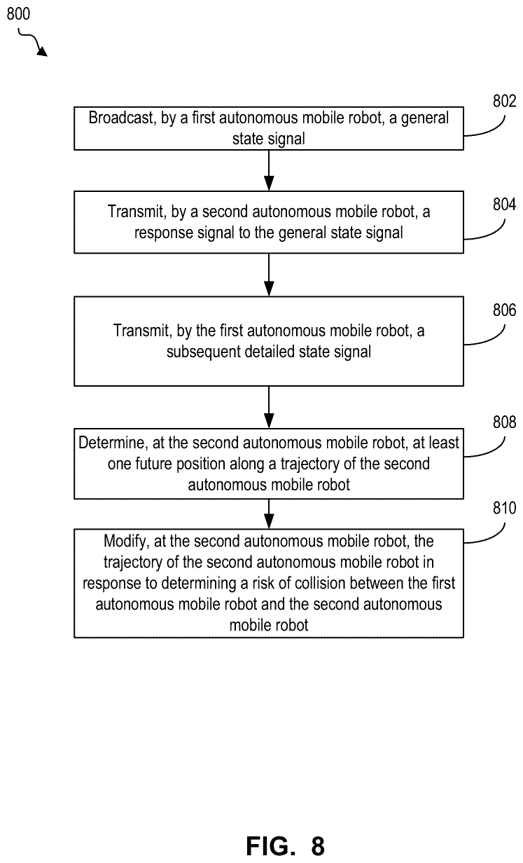

Referring next to FIG. 8, shown therein is a flowchart illustrating another example method 800 for collision avoidance for autonomous mobile robots 210 using short-range position sharing. The method 800 may be similar to method 400. However, the method 800 may not involve broadcasting a low power presence signal and can enable the autonomous mobile robots 210 to communicate state information without requiring a connection to first be established between the autonomous mobile robots 210.

At 802, the autonomous mobile robot 210a can broadcast a general state signal. The general state signal can be broadcasted via a short-range communication protocol. Similar to the low power presence signal of method 400, the general state signal can be transmitted using any unidirectional short-range communication protocol that allows the autonomous mobile robot 210a to broadcast information without the use of a base station and without first requiring the autonomous mobile robot 210a to establish a connection with other autonomous mobile robots.

The first state signal transmitted can include general state information about the autonomous mobile robot 210a, for example, a current position, a current velocity and in some cases a robot identifier. The rate of transmission of the state signal can be constant, or can vary, similar to the rate of transmission of the low power presence signal. For example, the rate of transmission of the state signal can vary based on the current velocity of the autonomous mobile robot 210a, the number of density of nearby autonomous mobile robots 210, changes in the autonomous mobile robot's 210a mission or trajectory, the type of facility and/or on the network resources available. The general state signal can be a lightweight signal that consumes little power and network resources,

In some embodiments, the general state signal can include a future expected position and a future expected velocity of the autonomous mobile robot 210a and timing information associated with the future expected position and future expected velocity.

Autonomous mobile robots 210 located within the range of the short-range communication protocol can detect the broadcasted general state signal.

At 404, autonomous mobile robot 210b can transmit a response signal in response to the signal broadcasted by autonomous mobile robot 210a. The autonomous mobile robot 210b can transmit a response signal using the communication component 216 of the autonomous mobile robot 210b.

At 806, in response to detecting the response signal transmitted by autonomous mobile robot 210b, autonomous mobile robot 210a transmits to autonomous mobile robot 210b a detailed state signal. The detailed state signal can include additional information about the autonomous mobile robot 210a that is not included in the general state signal. For example, the detailed state signal can include information about a shape and/or size of the autonomous mobile robot 210a or of the load transported by the autonomous mobile robot 210a and information about the mission of the autonomous mobile robot 210a. In embodiments where the general state signal does not include a robot identifier, a future expected position of the autonomous mobile robot 210a and/or a future expected velocity of the autonomous mobile robot 210a, the detailed state signal can include such information.

In some embodiments, the detailed state signal can include more detailed position and/or velocity information than the general state signal. For example, the detailed state signal can have a higher resolution and/or can include more precise position and/or velocity information.

The state signal can be transmitted using the same short-range communication protocol as the general state signal or can be transmitted using another short-range communication protocol.

At 808, similar to 408, autonomous mobile robot 210b determines at least one future position of the autonomous mobile robot 210b along its trajectory.

At 810, similar to 410, autonomous mobile robot 210b modifies its trajectory in response to determining a risk of collision between autonomous mobile robot 210b and predicted future position of the autonomous mobile robot 210a.

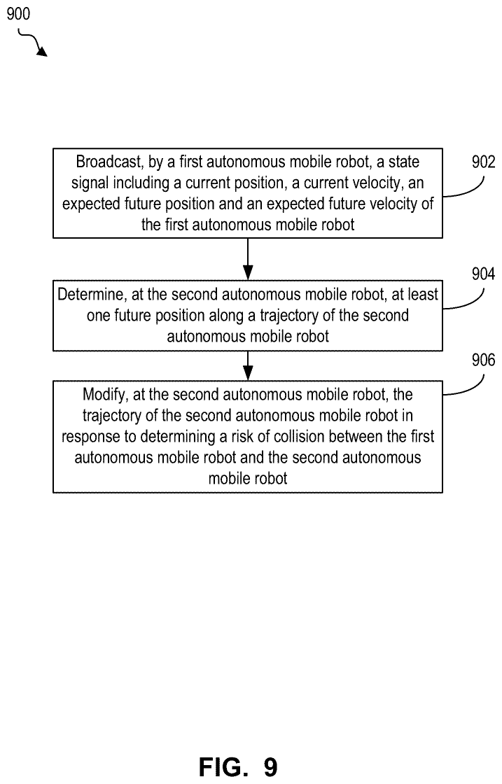

Referring next to FIG. 9, shown therein is a flowchart illustrating another example method 900 for collision avoidance for autonomous mobile robots 210 using short-range position sharing. The method 900 may be similar to method 400. However, the method 900 may not involve broadcasting a low power presence signal and can enable the autonomous mobile robots 210 to communicate state information without requiring a connection to first be established between the autonomous mobile robots 210.

Instead, at 902, the autonomous mobile robot 210a can broadcast a state signal. The state signal transmitted can be substantially similar to the state signal broadcasted at 406 of method 400. The rate of transmission of the state signal can be constant, or can vary, similar to the rate of transmission of the low power presence signal. For example, the rate of transmission of the state signal can vary based on the current velocity of the autonomous mobile robot 210a, the number of density of nearby autonomous mobile robots 210, changes in the autonomous mobile robot's 210a mission or trajectory, the type of facility and/or on the network resources available.

At 904, autonomous mobile robot 210b determines at least one future position of the autonomous mobile robot 210b along its trajectory. For example, the vehicle processor 212 of autonomous mobile robot 210b can determine a future position of the autonomous mobile robot 210b at a given time based on the trajectory to the destination location of the autonomous mobile robot 210b previously determined by the vehicle processor 212. Alternatively, the autonomous mobile robot 210b can determine its future position based on its current position, current velocity and expected future velocity.

At 910, autonomous mobile robot 210b modifies its trajectory in response to determining a risk of collision between autonomous mobile robot 210b and autonomous mobile robot 210a, based at least on at least one future position and the predicted future position of the autonomous mobile robot 210a.

Though methods 400, 800, 900 have been described with respect to autonomous mobile robot 210a and autonomous mobile robot 210b, methods 400, 800, 900 can be used to avoid collisions between an autonomous mobile robot 210b and a dynamic obstacle that may not be an autonomous mobile robot 210. A dynamic obstacle can be any type of moving object that includes a communication component that can broadcast a state signals and in some cases, low power presence signals via a short-range communication protocol. For example, a dynamic obstacle can include an automated guided vehicle, a human-driven vehicle or other human-driven equipment.

For example, with reference to method 400, at 402, a dynamic obstacle can broadcast a low power signal, which can be detected by an autonomous mobile robot 210. The dynamic obstacle can then transmit state information to the autonomous mobile robot 210 at 406.

Similarly, with reference to method 800, at 802, the dynamic obstacle can broadcast a general state signal, which can be detected by an autonomous mobile robot 210. The dynamic obstacle can then transmit detailed state information to the autonomous mobile robot 210 at 806.

Similarly, with reference to method 900, at 902, the dynamic obstacle can broadcast the state signal, which can be detected by an autonomous mobile robot 210.

It will be appreciated that numerous specific details are set forth in order to provide a thorough understanding of the example embodiments described herein. However, it will be understood by those of ordinary skill in the art that the embodiments described herein may be practiced without these specific details. In other instances, well-known methods, procedures and components have not been described in detail so as not to obscure the embodiments described herein. Furthermore, this description and the drawings are not to be considered as limiting the scope of the embodiments described herein in any way, but rather as merely describing the implementation of the various embodiments described herein.

The embodiments of the systems and methods described herein may be implemented in hardware or software, or a combination of both. These embodiments may be implemented in computer programs executing on programmable computers, each computer including at least one processor, a data storage system (including volatile memory or non-volatile memory or other data storage elements or a combination thereof), and at least one communication interface. For example and without limitation, the programmable computers (referred to above as computing devices) may be a server, network appliance, embedded device, computer expansion module, a personal computer, laptop, personal data assistant, cellular telephone, smart-phone device, tablet computer, a wireless device or any other computing device capable of being configured to carry out the methods described herein.

In some embodiments, the communication interface may be a network communication interface. In embodiments in which elements are combined, the communication interface may be a software communication interface, such as those for inter-process communication (IPC). In still other embodiments, there may be a combination of communication interfaces implemented as hardware, software, and combination thereof.

Program code may be applied to input data to perform the functions described herein and to generate output information. The output information is applied to one or more output devices, in known fashion.

Each program may be implemented in a high level procedural or object oriented programming and/or scripting language, or both, to communicate with a computer system. However, the programs may be implemented in assembly or machine language, if desired. In any case, the language may be a compiled or interpreted language. Each such computer program may be stored on a storage media or a device (e.g. ROM, magnetic disk, optical disc) readable by a general or special purpose programmable computer, for configuring and operating the computer when the storage media or device is read by the computer to perform the procedures described herein. Embodiments of the system may also be considered to be implemented as a non-transitory computer-readable storage medium, configured with a computer program, where the storage medium so configured causes a computer to operate in a specific and predefined manner to perform the functions described herein.

Furthermore, the system, processes and methods of the described embodiments are capable of being distributed in a computer program product comprising a computer readable medium that bears computer usable instructions for one or more processors. The medium may be provided in various forms, including one or more diskettes, compact disks, tapes, chips, wireline transmissions, satellite transmissions, internet transmission or downloadings, magnetic and electronic storage media, digital and analog signals, and the like. The computer useable instructions may also be in various forms, including compiled and non-compiled code.

Various embodiments have been described herein by way of example only. Various modification and variations may be made to these example embodiments without departing from the spirit and scope of the invention, which is limited only by the appended claims.

We claim:

1. A system for collision avoidance for autonomous mobile robots operating within a facility using short-range position sharing, the system comprising:
a first autonomous mobile robot comprising a first communication component configured to:
broadcast a low power presence signal via a short-range communication protocol;
in response to detecting a response signal from a second autonomous mobile robot, transmit, to the second autonomous mobile robot, a state signal comprising at least a current position and a current velocity of the first autonomous mobile robot;
the second autonomous mobile robot comprising a processor operable to:
determine at least one future position of the second autonomous mobile robot along a trajectory of the second autonomous mobile robot; and
modify the trajectory of the second autonomous mobile robot in response to determining a risk of collision, based at least on the at least one future position of the second autonomous mobile robot and at least one predicted future position of the first autonomous mobile robot along a trajectory of the first autonomous mobile robot, the at least one predicted future position of the first autonomous mobile robot determined based at least on the current position and the current velocity of the first autonomous mobile robot.

2. The system of claim 1, wherein the first autonomous mobile robot is a material transport mobile robot having an overhanging load and wherein the state signal comprises dimensions of the overhanging load.

3. The system of claim 1, wherein a rate of transmission of the low power presence signal is based in part on the current velocity of the first autonomous mobile robot.

4. The system of claim 1, wherein the state signal is transmitted via a second short-range communication protocol that is different from the short-range communication protocol of the low power presence signal.

5. The system of claim 1, wherein the state signal is transmitted via the short-range communication protocol.

6. The system of claim 1, wherein the second autonomous mobile robot comprises a second communication component configured to transmit a content of the state signal of the first autonomous mobile robot to a third autonomous mobile robot.

7. The system of claim 1, wherein the state signal further comprises at least one expected future position and at least one expected future velocity of the first autonomous mobile robot, and wherein the processor of the second autonomous mobile robot is operable to:
determine the at least one predicted future position of the first autonomous mobile robot based at least on the at least one expected future position and the at least one expected future velocity of the first autonomous mobile robot.

8. The system of claim 1, wherein the state signal further comprises mission information of the first autonomous mobile robot, the mission information comprising one or more of a mission type of the first autonomous mobile robot, a trajectory of the first autonomous mobile robot, a destination of the first autonomous mobile robot and a priority of the mission and wherein the processor of the second autonomous mobile robot is operable to modify the trajectory of the second autonomous mobile robot based on the mission information.

9. The system of claim 1, wherein the state signal comprises a robot identifier of the first autonomous mobile robot, and wherein the second autonomous mobile robot is configured to retrieve, from a data storage, dimensions of a load of the first autonomous mobile robot based on the robot identifier and wherein the processor of the second autonomous mobile robot is operable to determine the risk of collision based on the dimensions of the load of the first autonomous mobile robot.

10. The system of claim 1, wherein the state signal comprises a distance of the first autonomous mobile robot to a landmark within the facility and wherein the processor of the second autonomous mobile robot is operable to update a localization information of the second autonomous mobile robot based on the distance of the first autonomous mobile robot to the landmark and a signal strength of the state signal.

11. A method for collision avoidance for autonomous mobile robots operating within a facility using short-range position sharing, the method comprising operating a processor of a first autonomous mobile robot to:
detect a low power presence signal broadcasted by a second autonomous mobile robot via a short-range communication protocol;
transmit a response signal to the low power presence signal to the second autonomous mobile robot;
receive, from the second autonomous mobile robot, a state signal comprising at least a current position and a current velocity of the second autonomous mobile robot;
determine at least one future position of the first autonomous mobile robot along a trajectory of the first autonomous mobile robot; and
modify the trajectory of the first autonomous mobile robot in response to determining a risk of collision, based at least on the at least one future position of the first autonomous mobile and at least one predicted future position of the second autonomous mobile robot along a trajectory of the second autonomous mobile robot the at least one predicted future position of the second autonomous mobile robot determined based at least on the current position and the current velocity of the second autonomous mobile robot.

12. The method of claim 11, wherein the second autonomous mobile robot is a material transport mobile robot having an overhanging load and wherein the state signal comprises dimensions of the overhanging load.

13. The method of claim 11, wherein a rate of transmission of the low power presence signal is based in part on the current velocity of the second autonomous mobile robot.

14. The method of claim 11, wherein the state signal is transmitted via a second short-range communication protocol that is different from the short-range communication protocol of the low power presence signal.

15. The method of claim 11, wherein the state signal is transmitted via the short-range communication protocol.

16. The method of claim 11, the method further comprises operating the processor of the first autonomous mobile robot to transmit a content of the state signal of the second autonomous mobile robot to a third autonomous mobile robot.

17. The method of claim 11, wherein the state signal further comprises at least one expected future position and at least one expected future velocity of the second autonomous mobile robot, and wherein the method further comprises operating the processor of the first autonomous mobile robot to:
determine the at least one predicted future position of the second autonomous mobile robot based at least on the at least one expected future position and the at least one expected future velocity of the second autonomous mobile robot.

18. The method of claim 11, wherein the state signal further comprises mission information of the second autonomous mobile robot, the mission information comprising one or more of a mission type of the second autonomous mobile robot, a trajectory of the second autonomous mobile robot, a destination of the second autonomous mobile robot and a priority of the mission and wherein the method further comprises operating the processor of the first autonomous mobile robot to modify the trajectory of the first autonomous mobile robot based on the mission information.

19. The method of claim 11, wherein the state signal comprises a robot identifier of the second autonomous mobile robot, and wherein the method further comprises operating the processor of the first autonomous mobile robot to:
retrieve, from a data storage, dimensions of a load of the second autonomous mobile robot based on the robot identifier; and
determine the risk of collision based on the dimensions of the load of the second autonomous mobile robot.

20. The method of claim 11, wherein the state signal comprises a distance of the second autonomous mobile robot to a landmark within the facility and wherein the method further comprises operating the processor of the first autonomous mobile robot to:
update a localization information of the first autonomous mobile robot based on the distance of the second autonomous mobile robot to the landmark and a signal strength of the state signal.
